(19) United States
(12) Patent Application Publication
(10) Pub. No.: US 2018/0147894 A1
(43) Pub. Date: May 31, 2018

(54) PNEUMATIC TIRE

(71) Applicant: TOYO TIRE & RUBBER CO., LTD., Itami-shi (JP)

(72) Inventor: Hiroyuki Haseda, Itami-shi (JP)

(73) Assignee: TOYO TIRE & RUBBER CO., LTD., Itami-shi (JP)

(21) Appl. No.: 15/674,979

(22) Filed: Aug. 11, 2017

(30) Foreign Application Priority Data
Nov. 25, 2016 (JP) 2016-228536

(51) Int. Cl. B60C 11/13

(52) U.S. Cl. CPC B60C 11/1323; B60C 11/01

(57) ABSTRACT

A pneumatic tire has a narrow groove extending in a tire circumferential direction. The narrow groove being formed in a shoulder land portion of a tread. An inside concave curved surface and an outside concave curved surface are formed in a groove bottom port ion of the narrow groove. The inside concave curved surface is obtained by depressing a groove wall in a tread center side. The outside concave curved surface is obtained by depressing a groove wall in a tread end side. The groove bottom, portion of the narrow groove is provided as a shape which is wider than an opening portion of the narrow groove and is rounded. A height of the inside concave curved surf ace measured along a depth direction of the narrow groove is greater than a height of the outside concave curved surface.

### BACKGROUND OF THE INVENTION

### Field of the Invention

The present invention relates to a pneumatic tire in which a narrow groove extending in a tire circumferential direction is formed in a shoulder land portion of a tread.

### Description of the Related Art

There has been known a pneumatic tire in which a narrow groove extending in a tire circumferential direction is formed in a shoulder rib (an example of a shoulder land portion) of a tread, for example, as disclosed in patent documents 1 and 2. The shoulder rib is sectioned into a main rib in a tread center side, and a sacrificed rib in a tread end side by the narrow groove. In the tire structured as mentioned above, since the wear can be concentrated into the sacrificed rib, the wear of the main rib can be suppressed, and an irregular wear resistance is improved. The narrow groove as mentioned above is also called as a defense groove, and is formed in the pneumatic tire for a heavy load which is mainly used in a truck and a bus.

However, since the main rib may generate the local irregular wear even if the narrow groove is provided, there has been further room for improvement of the irregular wear resistance. As a result of search by the inventor of the present invention, there has been found that a ground pressure tends to become high in the tread end side edge of the main rib and the main rib generates the irregular wear due to the tendency. Further, in the tire as mentioned above, it is necessary to prevent a so-called tear that the sacrificed rib is scattered in such a manner as to be torn. Particularly, if the distortion is concentrated on the groove bottom portion of the narrow groove and any crack is generated, the groove bottom crack extends to the tread end side and causes the tear. Therefore, it is important to enhance a tear resistance while suppressing the generation of the groove bottom crack.

Each of the patent documents 1 and 2 describes the pneumatic tire in which the narrow groove extending in the tire circumferential direction is formed in the shoulder rib of the tread. In the patent document 1, the groove bottom portion of the narrow groove is formed by depressing only a groove wall in one side which forms the tread center side. As a result, a radius of curvature tends to become small at a position which connects a groove wall in the tread end side of the narrow groove and the groove bottom, and it is thought that there is room for improvement in view of enhancement of a groove bottom crack resistance.

In FIGS. 1 and 2 of the patent document 2, the groove bottom portion of the narrow groove is formed by depressing only the groove wall in one side which forms the tread end side, and it. is thought that there is room for improvement in view of enhancement of the groove bottom crack resistance in the same manner as mentioned above. Further, the irregular wear in the main rib can not be suppressed. In the same manner, in FIG. 3, the groove bottom portion of the narrow groove is formed by depressing the groove walls in both sides of the tread center side and the tread end side. In the case that the depression in both sides is formed large, a rigidity of the sacrificed rib is lowered and the tear resistance is deteriorated. In the case that the depression in both sides is formed small, the local irregular wear in the main rib can not be sufficiently suppressed.

### PRIOR ART DOCUMENT

### Patent Document

Patent Document 1; WO2008/111582

Patent Document 2: JP-A-2001-260612

### SUMMARY Of THE INVENTION

The present invention is made by taking the actual condition mentioned above into consideration, and an object of the present invention is to provide a pneumatic tire in which a narrow groove extending in a tire circumferential direction is formed in a shoulder land portion, and the pneumatic tire is excellent in a groove bottom crack resistance, an irregular wear resistance and a tear resistance.

The present invention provides a pneumatic tire comprising a narrow groove extending in a tire circumferential direction, the narrow groove being formed in a shoulder land portion of a tread,

wherein an inside concave curved surface and an outside concave curved surface are formed in a groove bottom portion of the narrow groove, the inside concave curved surface being obtained by depressing a groove wall in a tread center side and the outside concave curved surface being obtained by depressing a groove wall in a tread end side, and the groove bottom portion of the narrow groove is provided as a shape which is wider than an opening portion of the narrow groove and is rounded, and

wherein a height of the inside concave curved surface measured along a depth direction of the narrow groove is greater than a height of the outside concave curved surface.

In the tire, the groove bottom portion of the narrow groove is provided as the shape which is wider than the opening portion of the narrow groove and is rounded, the narrow groove in which the inside concave curved surface and the outside concave curved surface are formed as mentioned above. As a result, even in the case that the shoulder land portion is exposed to the great input by the tire running on the stone curve, the distortion is hard to be locally concentrated on the groove bottom portion of the narrow groove, and an excellent groove bottom crack resistance can be achieved. Further, since the height of the inside concave curved surface is made relatively great, the ground pressure in the tread end side edge of the main rib can be sufficiently lowered, the local irregular wear in the main rib can be suppressed, and the excellent irregular wear resistance can be achieved. Further, since the height of the outside concave curved surface is made relatively small, it is possible to suppress the rigidity reduction of the sacrificed rib, and the excellent tear resistance can be achieved.

It is preferable that the height of the outside concave curved surface is between 0.4 and 0.8 times of the height, of the inside concave curved surface. According to the structure mentioned above, the outside concave curved surface does not become too large, and it is possible to secure the rigidity of the sacrificed rib and well enhance the tear resistance.

It is preferable that a depression width of the inside concave curved surface is greater than a depression width of the outside concave curved surface. According to the structure mentioned above, it is possible to more sufficiently lower the ground pressure in the tread end side edge of the main rib and it is possible to effectively improve the irregular wear resistance. Further, it is possible to appropriately suppress the rigidity reduction of the sacrificed rib and it is possible to well enhance the tear resistance.

It is preferable that the most depressing portion in the inside concave curved surface is positioned closer to an outer side in a tire radial direction than the most depressing portion in the outside concave curved surface. According to the structure mentioned above, it is possible to more sufficiently lower the ground pressure in the tread end side edge of the main rib and it is possible to effectively improve the irregular wear resistance.

In order to form the inside concave curved surface and the outside concave curved surface having the height relationship mentioned above, the radius of curvature of the inside concave curved surface is preferably larger than the radius of curvature of the outside concave curved surface in the tire meridian cross section.

### BRIEF DESCRIPTION OF THE DRAWINGS

FIG. 1 is a cross sectional view of a tire meridian schematically showing one example of a tread of a pneumatic tire according to the present invention; and

FIG. 2 is an enlarged view showing a substantial part of FIG. 1.

### DETAILED DESCRIPTION OF THE PREFERRED EMBODIMENT

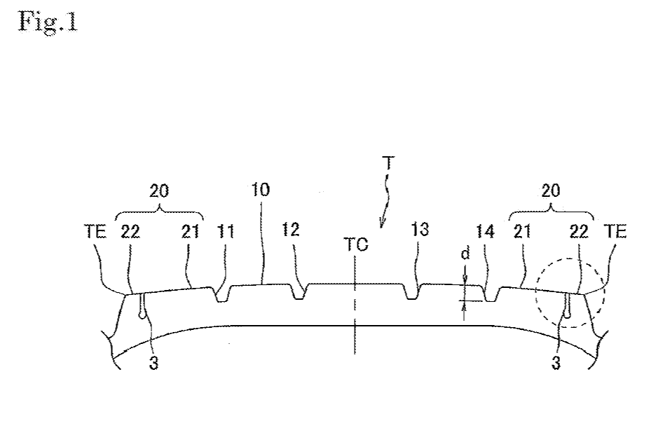

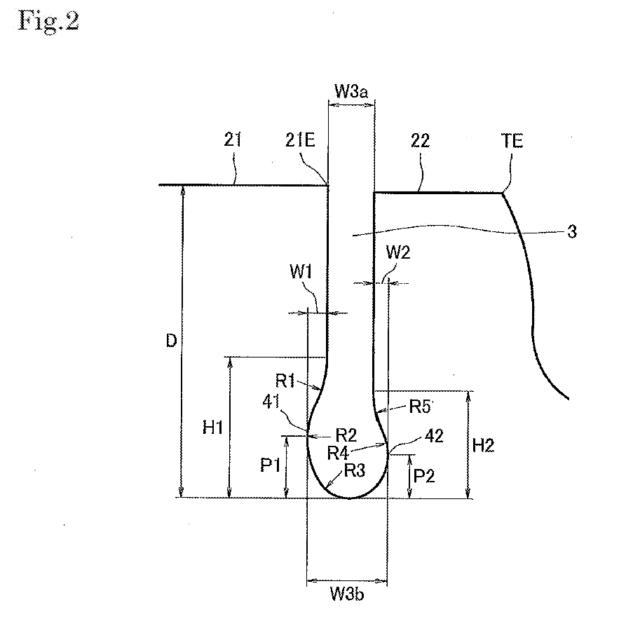

An embodiment of the present invention will be explained with reference to the drawings. FIG. 1 schematically shows a tread 10 of a pneumatic tire T according to the present embodiment. FIG. 2 shows a substantial part which is surrounded by a broken line frame in FIG. 1 in an enlarged manner.

The pneumatic tire T has a pair of beads (not shown) and a pair of side walls which extend to an outer side in a tire radial direction from the beads, in the same manner as the general pneumatic tire, and the tread 10 is provided in such a manner as to be connected to an outer end in the tire radial direction of each of the side walls. Further, a carcass extending like a toroidal shape is provided between a pair of beads, and a reinforcing member such as a belt reinforcing the carcass is buried in the tread 10, however, an illustration of them is omitted.

A plurality of main grooves extending in a tire circumferential direction are formed in the tread 10, and four main grooves 11 to 14 are formed in the present embodiment. The tread 10 is sectioned into a plurality of land portions including shoulder land portions 20 by a plurality of main grooves. The shoulder land portion 20 is positioned between each of tread ends TE and respective one of the shoulder main grooves 11 and 14 positioned in the outermost sides in the tire width direction. In the present embodiment, the shoulder land portion 20 is provided as a shoulder rib which continuously extends in the tire circumferential direction, however, is not limited to this.

In the tire T, the narrow groove 3 extending in the tire circumferential direction is formed in the shoulder land portion 20 of the tread 10. The narrow groove 3 extends continuously in a straight line shape or a zigzag shape along the tire circumferential direction. A depth D of the narrow groove 3 is, for example, in a range which is 0.3 to 1.5 times of a depth d of the shoulder main grooves 11 and 14. The narrow groove 3 is formed narrower than the shoulder main grooves 11 and 14 on a surface of the tread 10, and a width W3a of an opening portion of the narrow groove 3 is, for example, in a range between 0.3 and 5.0 mm. The narrow groove 3 may be provided only in the shoulder land portion 20 in one side, however, is preferably provided in the shoulder land portions 20 in both sides for achieving an excellent irregular wear resistance.

The shoulder land portion 20 is sectioned into a main rib 21 in a tread center TC side, and a sacrificed rib 22 in a tread end TE side by the narrow groove 3. The narrow groove 3 is positioned in the vicinity portion of the tread end TE of the shoulder land portion 20, and the main rib 21 is provided wider than the sacrificed rib 22. The narrow groove 3 is formed into an approximately round bottom flask shape in a tire meridian cross section, however, a groove bottom portion thereof has a laterally asymmetrical shape.

As shown in FIG. 2 in an enlarged manner, an inside concave curved surface 41 and an outside concave curved surface 42 are formed in the groove bottom portion of the narrow groove 3, the inside concave curved surface 41 being obtained by depressing a groove wall in the tread center TC side, and the outside concave curved surface 42 being obtained by depressing a groove wall in the tread end TE side. The inside concave curved surface 41 is formed by a flection surface which is depressed to an inner side in a tire width direction and has a circular arc cross sectional shape, and the outside concave curved surface 42 is formed by a flection surface which is depressed to an outer side in the tire width direction and has a circular arc cross sectional shape. The inside concave curved surface 41 and the outside concave curved surface 42 are both extended annularly along the tire circumferential direction.

The groove bottom portion of the narrow groove 3 has the inside concave curved surface 41 and the outside concave curved surface 42 in both sides thereof, and is provided as a shape which is rounded as a whole. The inside concave curved surface 41 is connected smoothly to the outside concave curved surface 42 with no step via series of plural circular arcs as mentioned later. Further, the groove bottom portion of the narrow groove 3 is wider than an opening portion, and the maximum width W3b in the groove bottom portion is larger than the width K3a of the opening portion. Since it is possible to make a radius of curvature of a surface of the groove bottom portion of the narrow groove 3 large by forming the groove bottom portion of the narrow groove 3 wider than the opening portion, this structure can contribute to improvement of the groove bottom crack resistance.

In the tire T, a height H1 of the inside concave curved surface 41 is larger than a height H2 of the outside concave curved surface 42, The heights H1 and H2 are measured along a depth direction of the narrow groove 3. The depth direction of the narrow groove 3 indicates a direction which passes a width center of the opening portion of the narrow groove 3 and is along the normal line of the surface of the tread 10, in the tire meridian cross section. The height H1 is a dimension from a bottom surface of the narrow groove 3 to an inside end in the tire radial direction of a straight line forming the groove wall in the tread center TC side in the tire meridian cross section (a boundary between a circular arc having a radius of curvature R1 and the straight line). The height H2 is a dimension from the bottom surface of the narrow groove 3 to an inside end in the tire radial direction of a straight line forming the groove wall in the tread end TE side in the tire meridian cross section (a boundary between a circular arc having a radius of curvature R5 and the straight line).

In the tire T, the groove bottom portion where the inside concave curved surface 41 and the outside concave curved surface 42 are formed as mentioned above is provided as the shape which is wider than the opening portion of the narrow groove 3 and is rounded, As a result, even when the shoulder land portion 20 is exposed to the great input due to the tire T running on a stone curb, the distortion is hard to be locally concentrated on the groove bottom portion of the narrow groove 3, and an excellent groove bottom crack resistance can be achieved. Further, since the height HI of the inside concave curved surface 41 is great, an excellent irregular wear resistance can be achieved by sufficiently lowering the ground pressure of the tread end side edge 21E in the main rib 21, and suppressing the local irregular wear in the main rib 21. Further, since the height H2 of the outside concave curved surface 42 is small, an excellent tear resistance can be achieved by suppressing the rigidity reduction of the sacrificed rib 22.

The height H1 of the inside concave curved surface 41 is preferably between 0.1 and 0.5 times of the depth D of the narrow groove 3. Since the height H1 is equal to or more than 0.1 times of the depth D, it is possible to suitably secure the size of the inside concave curved surface 41. Therefore, this structure can contribute to the improvement of the irregular wear resistance. Further, since the height H1 is equal to or less than 0.5 times of the depth D, the inside concave curved surface 41 does not become too large, and it is possible to avoid an unnecessary rigidity reduction of the main rib 21. The heights H1 and H2 and the depth D are all measured in a no-load state.

The height H2 of the outside concave curved surface 42 is preferably between 0.4 and 0.8 times of the height H1 of the inside concave curved surface 41. Since the height H2 is equal to or more than 0.4 times of the height H1, it is possible to suitably secure the size of the groove bottom portion of the narrow groove 3. Therefore, this structure can contribute to the improvement of the grove bottom crack resistance. Further, since the height H2 is equal to or less than 0.8 times of the height H1, the outside concave curved surface 42 does not become too large, and it is possible to well enhance the tear resistance by securing the rigidity of the sacrificed rib 22.

In the present embodiment, a contour of the groove bottom portion of the narrow groove 3 is formed in the tire meridian cross section by connecting a plurality of circular arcs including the circular arc which is connected to the groove wall in the tread center TC side and has the radius of curvature R1, a circular arc which forms the inside concave curved surface 41 and has a radius of curvature R2, a circular arc which forms the bottom surface of the narrow groove 3 and has a radius of curvature R3, a circular arc which forms the outside concave curved surface 42 and has a radius of curvature R4, and the circular arc which is connected to the groove wall in the tread end TE side and has the radius of curvature R5. In order to satisfy a relationship of height H1>H2, the radius of curvature R2 of the inside concave curved surface 41 is preferably larger than the radius of curvature R4 of the outside concave curved surface 42.

In the present embodiment, a depression width of the inside concave curved surface 41 is larger than a depression width W2 of the outside concave curved surface 42. As a result, it is possible to effectively improve the irregular wear resistance by sufficiently lowering the ground pressure in the tread end side edge 21E of the main rib 21, and it is possible to well enhance the tear resistance by suitably suppressing the rigidity reduction of the sacrificed rib 22. The depression width W1 is measured along the tire width direction on the basis of the groove wall in the tread center TC side, and is set, for example, to 0.1 to 1.0 times of the width W3a of the opening portion. The depression width W2 is measured along the tire width direction on the basis of the groove wall in the tread end TE side, and is set, for example, to 0.05 and 0.5 times of the width W3a of the opening portion.

In the present embodiment, the most depressing portion in the inside concave curved surface 41 is positioned closer to the outer side in the tire radial direction than the most depressing portion in the outside concave curved surface 42. More specifically, the relationship P1>P2 is satisfied between the height P1 of the most depressing portion to the inner side in the tire width direction of the inside concave curved surface 41 and the height P2 of the most depressing portion to the outer side in the tire width direction of the outside concave curved surface 42, on the basis of the bottom surface of the narrow groove 3. According to the structure mentioned above, the irregular wear resistance can be effectively improved by sufficiently lowering the ground pressure in the tread end side edge 21E of the main rib 21. The height P2 is set, for example, to 0.4 to 0.8 times of the height P1.

The pneumatic tire according to the present invention is the same as the normal pneumatic tire except the matter that the narrow groove is formed by the shoulder land portion of the tread as mentioned above, and the conventionally known materials, shapes and structures can be all employed in the present invention.

Since the pneumatic tire according to the present invention can achieve the excellent groove bottom crack resistance, irregular wear resistance and tear resistance on the basis of the actions and effects as mentioned above, the pneumatic tire can be useful for the pneumatic tire for heavy load which is used particularly to the truck and the bus.

The present invention is not limited to the embodiment mentioned above, but can be modified and changed variously within a range which doss not deviate from the scope of the present invention. For example, the tread pattern can be appropriately changed in correspondence to the used intended purposes and conditions.

### EXAMPLES

An example which concretely shows the structure and effect of the present invention will be explained. An evaluation of each of performances is executed as follows.

### (1) Irregular Wear Resistance

The tire was assembled in the wheel having the rim size 22.5×8.25, the pneumatic pressure was set to 760 kPa (TRA specified internal pressure), the traveling test was executed under the condition of the speed 80 km/h and the load 27.5 kN (TRA 100% load), and the irregular wear ratio of the tread was examined. The irregular wear ratio was calculated as a ratio (Sh/Ce) of a wear amount Sh of the shoulder land portion in relation to a wear amount Ce of the center land portion passing through the tread center. The closer to 1.00 the numerical value is, the more the irregular wear is suppressed, which indicates an excellent irregular wear resistance.

### (2) Groove Bottom Crack Resistance

The tire was assembled in the wheel having the rim size 22.5×8.25, the pneumatic pressure was set to 760 kPa, the traveling test was executed by using a dram with cleat under the condition of the speed 60 km/h and the load 21.8 kN, and the width of the groove bottom crack in the narrow groove was measured after traveling for 15, 000 km. The measured value was indexed on the assumption that the result of a comparative example 4 was set to 100. The smaller numerical value indicates that the generation of the groove bottom crack is more suppressed and the tire is more excellent in the groove bottom crack resistance. Since the groove bottom crack may be a starting point of the tear, the inferior groove bottom crack resistance can be evaluated as the inferior tear resistance.

### Comparative Examples and Working Examples

Comparative examples 1 to 4 and working examples 1 and 2 were obtained by differentiating the heights H1 and H2, the depression widths W1 and W2 and the heights P1 and P2 mentioned above, in the tire (size: 295/75R22.5) having the tread which is sectioned into five land portions by four main grooves. The other structures of the narrow groove than these dimensions and the other structures of the tire than the narrow groove are common in each of the examples. The width W3a of the opening portion is 2.0 mm in each of the examples. The comparative example 1 employs the narrow groove which does not have the inside concave curved surface and the outside concave curved surface, the comparative example 2 employs the narrow groove which has the inside concave curved surface but does not have the outside concave curved surface, and the comparative example 3 employs the narrow groove which has the outside concave curved surface but does not have the inside concave curved surface. Results of evaluation are shown in Table 1.

TABLE 1

| | | | | | Working | Working |
|---|---|---|---|---|---|---|
| | Comparative | Comparative | Comparative | Comparative | example | example |
| | example 1 | example 2 | example 3 | example 4 | 1 | 2 |
| H1 (mm) | — | 4.0 | — | 6.0 | 6.0 | 5.0 |
| H2 (mm) | — | — | 4.0 | 6.0 | 4.0 | 3.0 |
| W1 (mm) | — | 1.2 | — | 1.2 | 2.0 | 0.4 |
| W2 (mm) | — | — | 1.2 | 1.2 | 1.2 | 0.2 |
| P1 (mm) | — | 3.0 | — | 3.0 | 3.0 | 2.5 |
| P2 (mm) | — | — | 3.0 | 3.0 | 2.0 | 1.5 |
| Irregular wear | 1.20 | 1.10 | 1.20 | 1.10 | 1.00 | 1.05 |
| resistance | | | | | | |
| Groove bottom | 125 | 105 | 105 | 100 | 70 | 85 |
| crack | | | | | | |
| resistance | | | | | | |

From Table 1, it can be known that the working examples 1 and 2 can achieve the comparatively excellent irregular wear resistance and groove bottom crack resistance. Since the generation of the groove bottom crack is remarkable in the comparative examples 1 to 3 in comparison with the working examples 1 and 2, and there is fear that the tear is generated starting from the groove bottom crack, the working examples 1 and 2 can be evaluated to be more excellent in the tear resistance than the comparative examples 1 to 3. Since the comparative example 4 is great in the root depression of the sacrificed rib and the rigidity of the sacrificed rib is relatively low, the working examples 1 and 2 can be evaluated to be more excellent in the tear resistance than the comparative example 4.

What is claimed is:

1. A pneumatic tire comprising a narrow groove extending in a tire circumferential direction, the narrow groove being formed in a shoulder land portion of a tread,
wherein an inside concave curved surface and an outside concave curved, surface are formed in a groove bottom portion of the narrow groove, the inside concave curved surface being obtained by depressing a groove wall in a tread center side and the outside concave curved surface being obtained by depressing at groove wall in a tread end side, and the groove bottom portion of the narrow groove is provided as a shape which is wider than an opening portion of the narrow groove and is rounded, and
wherein a height of the inside concave curved surface measured along a depth direction of the narrow groove is greater than a height of the outside concave curved surface.

2. The pneumatic tire according to claim 1, wherein the height of the outside concave curved surface is between 0.4 and 0.8 times of the height of the inside concave curved surface.

3. The pneumatic tire according to claim 1, wherein a depression width of the inside concave curved surface is greater than a depression width of the outside concave curved surface.

4. The pneumatic tire according to claim 1, wherein the most depressing portion in the inside concave curved surface is positioned closer to an outer side in a tire radial direction than the most depressing portion in the outside concave curved surface.

5. The pneumatic tire according to claim 1, wherein a radius of curvature of the inside concave curved surface is greater than a radius of curvature of the outside concave curved surface in a tire meridian cross section.

6. The pneumatic tire according to claim 1, wherein the height of the inside concave curved surface is between 0.1 and 0.5 times of a depth of the narrow groove.

7. The pneumatic tire according to claim 1, wherein a depression width of the inside concave curved surface is between 0.1 to 1.0 times of a width of an opening portion of the narrow groove.

8. The pneumatic tire according to claim 1, wherein a depression width of the outside concave curved surface is between 0.05 and 0.5 times of a width of an opening portion of the narrow groove.
